(19) United States
(12) Patent Application Publication
(10) Pub. No.: US 2017/0192959 A1
(43) Pub. Date: Jul. 6, 2017

(54) APPARATUS AND METHOD FOR EXTRACTING TOPICS

(71) Applicant: Foundation of Soongsil University-Industry Cooperation, Seoul (KR)

(72) Inventors: Soowon LEE, Seoul (KR); Dongxu JIN, Seoul (KR)

(21) Appl. No.: 15/302,433

(22) PCT Filed: Nov. 25, 2015
(86) PCT No.: PCT/KR2015/012704

§ 371 Date: Oct. 6, 2016

(30) Foreign Application Priority Data
Jul. 7, 2015 (KR) 10-2015-0096801
Jul. 23, 2015 (KR) 10-2015-0104390

(51) Int. Cl. G06F 17/27

(52) U.S. Cl. CPC G06F 17/2785; G06F 17/274; G06F 17/2755

(57) ABSTRACT

Disclosed is an apparatus and method for extracting topics. The apparatus for extracting topics extracts an initial topic from a document using an LDA (latent Dirichlet allocation) and corrects topics which are duplicated and extracted or mixed through a similarity comparison between words included in the extracted initial topic, thereby extracting a final topic of the document.

### TECHNICAL FIELD

The present invention relates to an apparatus and method for extracting topics, and more particularly, to an apparatus and method for extracting topics for each document from a document set.

### BACKGROUND ART

A topic model is a model for extracting topics from a document set, which is used in natural language processing or the like. Compared to a vector-based model such as LSA that represents a document in a multi-dimensional manner using a word vector, the topic model represents topics included in a document as a probability distribution based on the fact that the distribution of words is different depending on specific topics. When the topic model is used, the corresponding document may be represented in a low-dimensional manner, and potential topics may be extracted.

Latent Dirichlet allocation (LDA) is a representative topic model used in natural language processing and is a probability model that allocates topics to the corresponding document. LDA may estimate the distribution of words for each topic from a given document, and analyze the distribution of words found in the given document, thereby observing which kind of topics the corresponding document contains.

LDA has been widely applied in a lot of research and products as a simple and practical topic model. Tencent, a Chinese IT company, has commercialized Peacock, a large-scale potential topic extracting project using LDA. The Peacock has learned 10 billion topics through a parallel computing method for decomposing and computing one billion X one hundred million-sized matrix. The learned topics are used in areas such as text word meaning extraction, recommendation systems, user performance determination, advertisement recommendation, and the like.

In extracting topics, there is a topic extracting method using a different word clustering method other than LDA. In addition, in extracting topics, there is a method for extracting topics for each region using news for each region through a word clustering method.

However, the use of the word clustering method may cause a problem of duplicated topic and a problem of mixed topics. In the duplicated topic problem, a specific topic is extracted as several topics, and in the mixed topics problem, several topics are mixed within an extracted single topic.

Thus, there is a demand for a method of extracting topics that can solve the above-described duplicated topic problem and mixed topics problem.

### DISCLOSURE

### Technical Problem

The present invention is directed to providing an apparatus and method for extracting topics, which may extract an initial topic from a document using LDA (latent Dirichlet allocation) and correct topics which are duplicated and extracted or mixed through a similarity comparison between words included in the extracted initial topic, thereby extracting a final topic of the document.

### Technical Solution

One aspect of the present invention provides a method for extracting topics including: collecting document data to extract nouns; extracting LDA (latent Dirichlet allocation) topics from the extracted nouns using an LDA technique; calculating similarities between topic candidate words within the LDA topics, and separating the LDA topics in accordance with the similarities between the topic candidate words; and merging the separated LDA topics in accordance with distances between the separated LDA topics to extract a final topic.

Here, calculating the similarities between the topic candidate words may include calculating a PMI (pointwise mutual information) value between the topic candidate words.

Furthermore, calculating the PMI value between the topic candidate words may include calculating the PMI value between the topic candidate words as a ratio of a probability that arbitrary two words among the topic candidate words simultaneously appear in a single sentence to a probability that the arbitrary two words separately appear.

Also, separating of the LDA topics may include generating a matrix indicating the topic candidate words and the PMI value between the topic candidate words, setting initial reference words in accordance with appearance frequencies of the topic candidate words within the matrix, and generating a TC (topic clique) for each of the set initial reference words to separate the LDA topics.

In addition, generating of the TC for each of the initial reference words may include generating the TC for each of the initial reference words using vertex words moved to the TC by performing a first process for determining a PMI value between the initial reference words and the remaining topic candidate words except for the initial reference words among the topic candidate words included in the matrix, deleting the topic candidate word whose PMI value with the initial reference word is 0 or less from the matrix, and moving the initial reference word to the vertex words of the TC in the matrix, a second process for setting, as a comparison reference word, the topic candidate word having the next highest priority in accordance with the appearance frequencies of the topic candidate words among the topic candidate words included in the matrix from which the topic candidate word whose PMI value with the initial reference word is 0 or less is deleted, determining a PMI value between each of the topic candidate word whose PMI value with the initial reference word is 0 or less and the topic candidate word included in the matrix from which the initial reference word is deleted with the comparison reference word, and deleting the topic candidate word whose PMI value with the comparison reference word is 0 or less, and a third process for repeatedly performing the second process until a single topic candidate word remains in the matrix in the second process.

Also, merging the separated LDA topics may include generating a new matrix as a union of vertex words included in arbitrary two TCs among the TCs for the initial reference words, detecting trunk lines in which a PMI value is 0 or less from the new matrix, calculating a distance between the TCs as a ratio of the number of the trunk lines in which a PMI value is 0 or less, which has been detected from the new matrix, to the number of overall trunk lines included in the new matrix, and merging the TCs in accordance with the distance between the TCs.

What's more, the merging of the TCs may include merging the arbitrary two TCs into a single topic.

Furthermore, the merging of the TCs may include merging the TCs by configuring a word set using vertex words corresponding to a portion in which the PMI value exceeds 0 in the new matrix.

Also, merging the TCs may include adding vertex words included in a negative vertex word set corresponding to a portion in which the PMI value is 0 or less in the new matrix to a positive vertex word set corresponding to a portion in which the PMI value exceeds 0 in the new matrix, in accordance with PMI values with vertex words included in the positive vertex word set, thereby merging the TCs.

Moreover, adding the vertex words included in the negative vertex word set to the positive vertex word set in accordance with the PMI values may include determining a PMI value between the vertex words included in the positive vertex word set while selecting the vertex words in accordance with the appearance frequencies among the vertex words included in the negative vertex word set and adding the selected vertex words to the positive vertex word set, determining whether the vertex word having the highest priority in accordance with the appearance frequencies in the negative vertex word set generates trunk lines in which a PMI value with at least one of the vertex words included in the positive vertex word set is 0 or less, and adding the vertex word having the highest priority to the positive vertex word set when the vertex word having the highest priority does not generates the trunk lines in which a PMI value with at least one of the vertex words included in the positive vertex word set is 0 or less.

Additionally, merging the TCs may include calculating an average PMI value of each of the arbitrary two TCs, and extracting the TC having a larger average PMI value between the arbitrary two TCs, thereby merging the TCs.

Another aspect of the present invention provides an apparatus for extracting topics including: a noun extraction unit that collects document data to extract nouns; an LDA topic extraction unit that extracts LDA topics from the extracted nouns using an LDA technique; a topic separation unit that calculates similarities between topic candidate words within the LDA topics, and separating the LDA topics in accordance with the similarities between the topic candidate words; and a topic merging unit that merges the separated LDA topics in accordance with distances between the separated LDA topics to extract a final topic.

### Advantageous Effects

According to an aspect of the above-described present invention, it is possible to more accurately extract topics by correcting the problem of duplicated topics and the problem of mixed topics.

### DESCRIPTION OF DRAWINGS

FIG. 1 is a block diagram illustrating an apparatus for extracting topics according to an embodiment of the present invention;

FIG. 2 is a diagram for describing an operation method of each of a morphological analysis unit and a noun extraction unit shown in FIG. 1;

FIG. 3 is a diagram illustrating topics extracted using a LDA (latent Dirichlet allocation) technique;

FIG. 4 is a diagram illustrating an example of calculating similarities between words within a topic;

FIG. 5 is a diagram illustrating an example in which words within a topic which have been extracted using a LDA technique are listed in order of appearance frequencies;

FIG. 6 is a diagram for describing a method for generating a matrix using the similarities calculated in FIG. 4;

FIG. 7 is a diagram for describing a method for generating a TC (topic clique) using a generated matrix;

FIG. 8 is a diagram for describing a method for generating a TC according to appearance frequency;

FIG. 9 is a diagram illustrating a process of generating a TC as an algorithm;

FIG. 10 is a diagram for describing a method for calculating a distance between TCs;

FIG. 11 is a diagram for describing a method for merging TCs;

FIG. 12 is a diagram illustrating a TC merge algorithm;

FIG. 13 is a flowchart illustrating a method for extracting topics according to an embodiment of the present invention;

FIG. 14 is a flowchart illustrating a method for extracting topics according to another embodiment of the present invention;

FIGS. 15A and 15B are flowcharts illustrating a method for extracting topics according to still another embodiment of the present invention;

FIG. 16 is a flowchart illustrating a method for extracting topics according to yet another embodiment of the present invention; and

FIGS. 17A and 17B are flowcharts illustrating a method for generating a TC according to an embodiment of the present invention.

### MODES OF THE INVENTION

In the following detailed description of the present disclosure, references are made to the accompanying drawings that show, by way of illustration, specific embodiments in which the present disclosure may be practiced. These embodiments are described in sufficient detail to enable those skilled in the art to practice one or more inventions in the present disclosure. It should be understood that various embodiments of the present disclosure, although different, are not necessarily mutually exclusive. For example, specific features, structures, and characteristics described herein, in connection with one embodiment, may be practiced within other embodiments without departing from the spirit and scope of the present disclosure. In addition, it should be understood that the location or arrangement of individual elements within each disclosed embodiment may be modified without departing from the spirit and scope of the present disclosure. The following detailed description is, therefore, not to be taken in a limiting sense, and the scope of the present disclosure is defined only by the appended claims, appropriately interpreted, along with the full range equivalent to what the claims claim. In the drawings, like reference numerals refer to the same or similar functions throughout the various views.

Hereinafter, preferred embodiments of the present invention will be described in more detail with reference to the accompanying drawings.

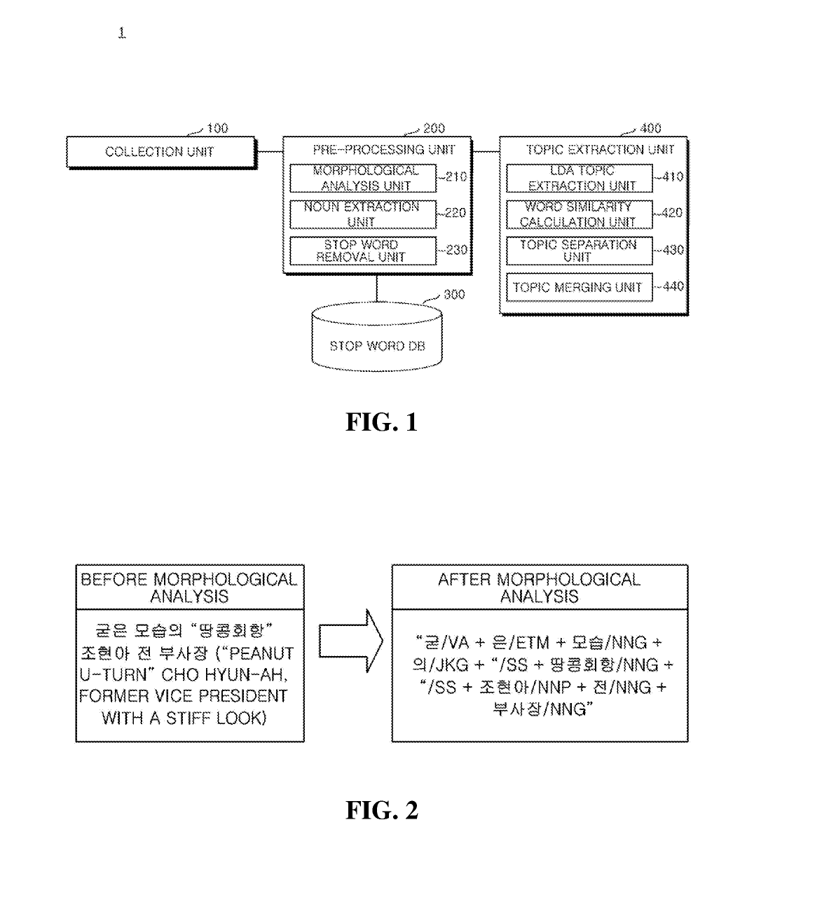

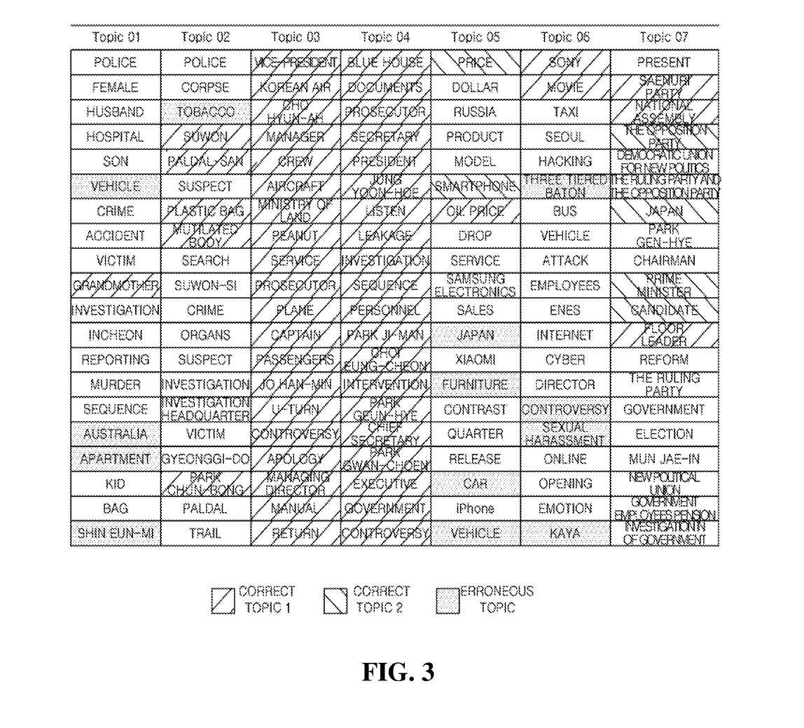

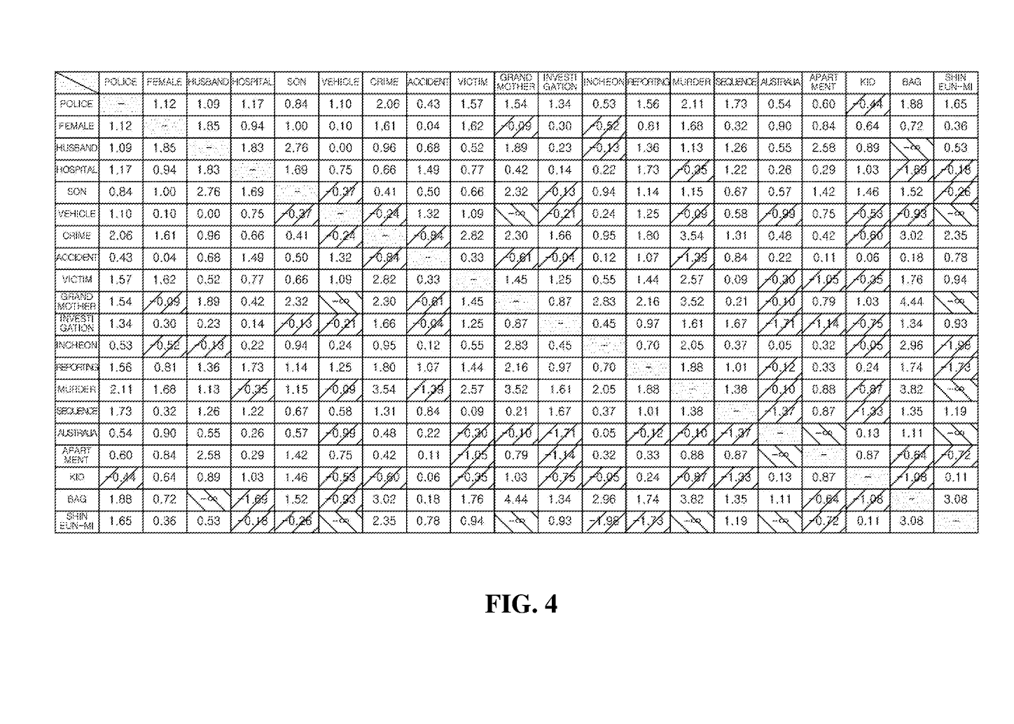

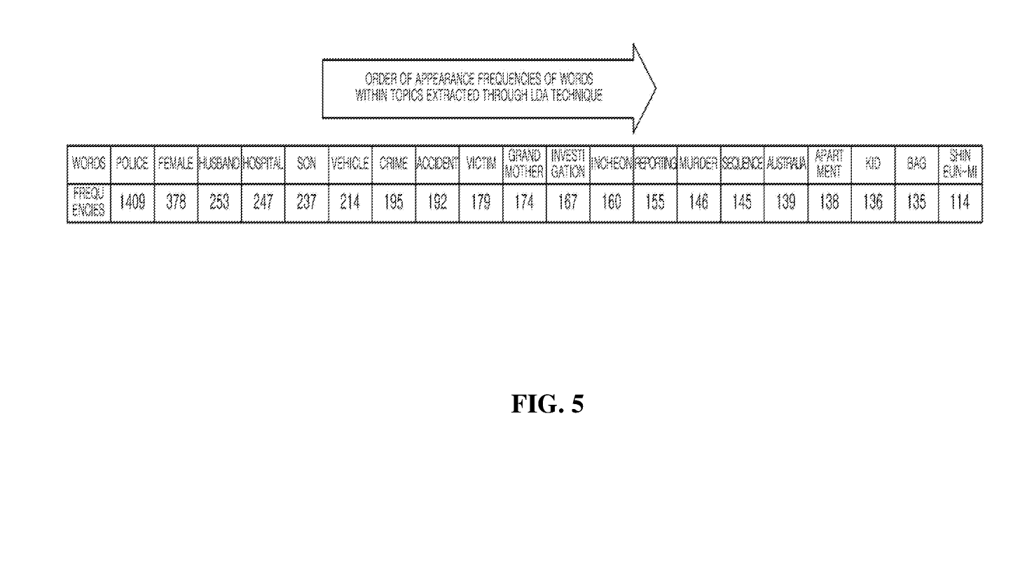

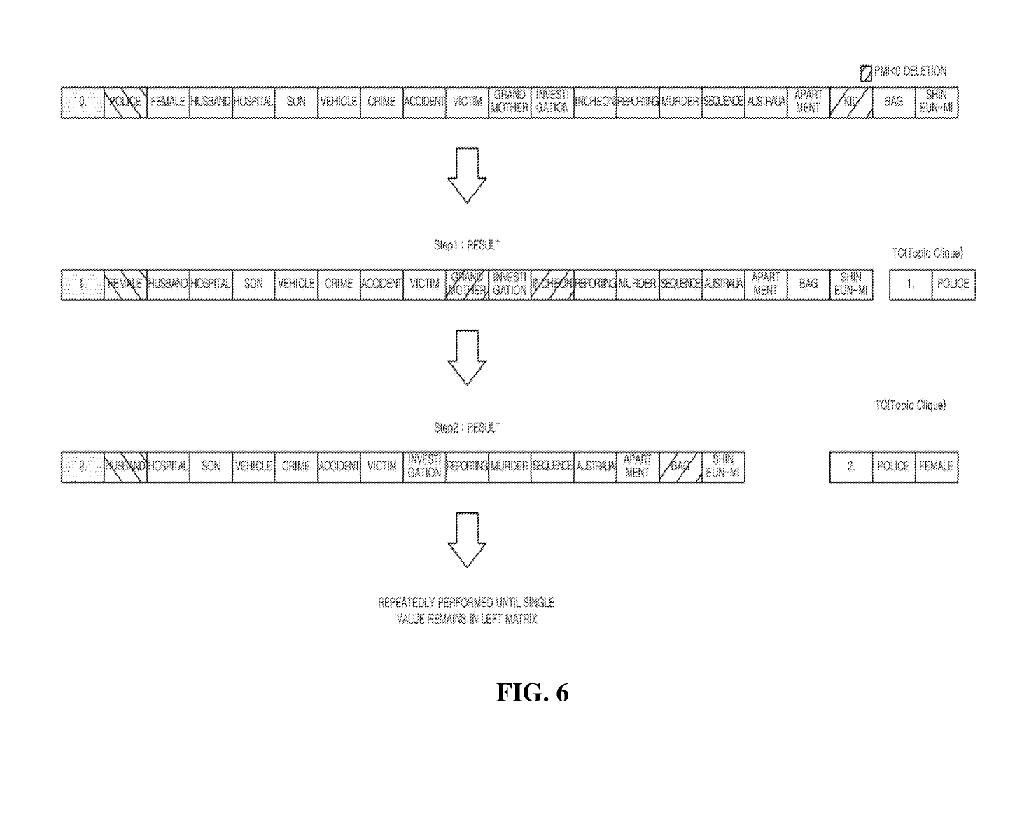

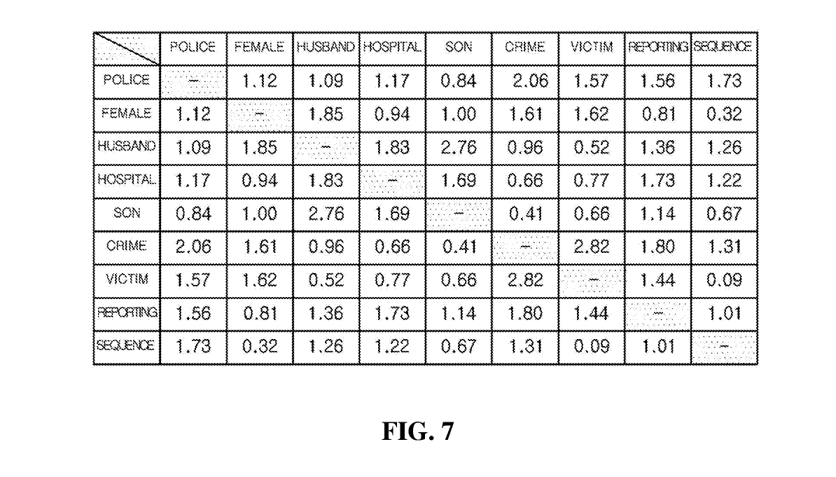

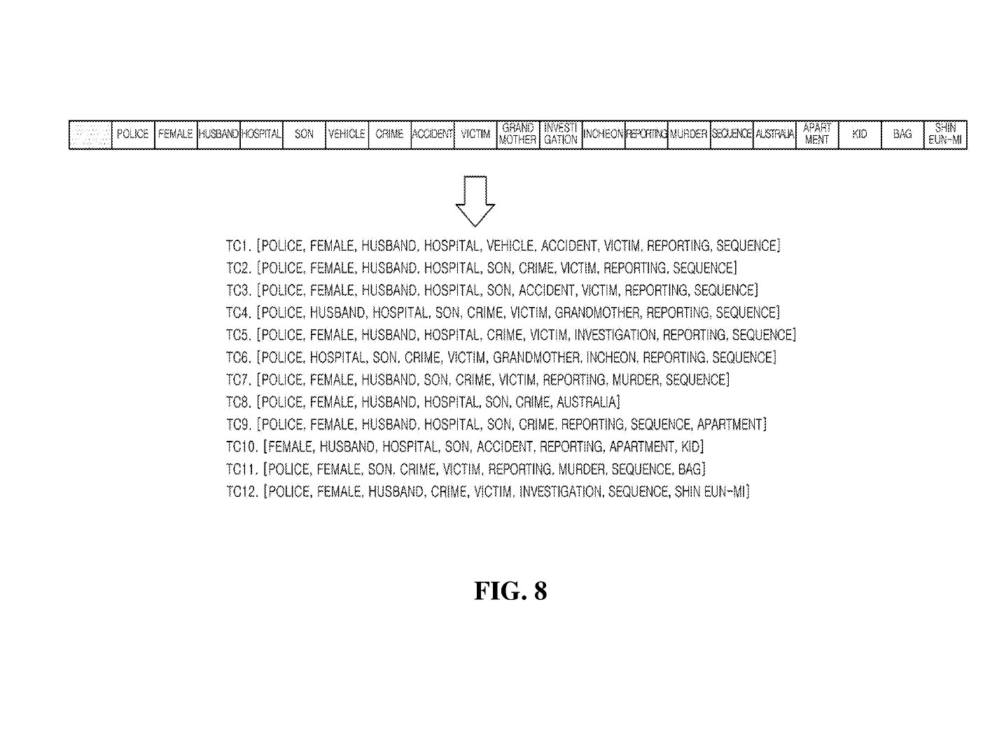

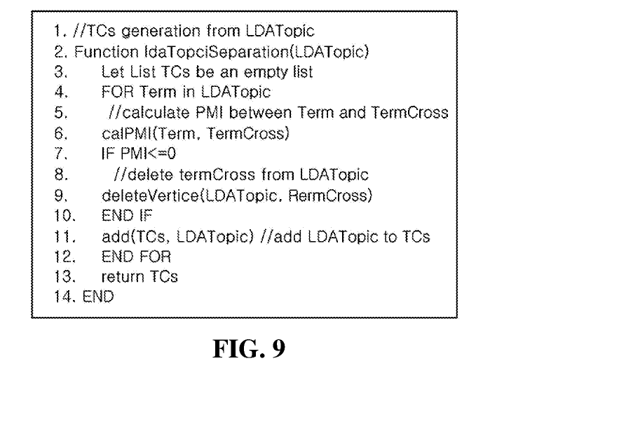

FIG. 1 is a block diagram illustrating an apparatus for extracting topics according to an embodiment of the present invention, FIG. 2 is a diagram for describing an operation method of each of a morphological analysis unit and a noun extraction unit shown in FIG. 1, FIG. 3 is a diagram illustrating topics extracted using a LDA (latent Dirichlet allocation) technique, FIG. 4 is a diagram illustrating an example of calculating similarities between words within a topic, FIG. 5 is a diagram illustrating an example in which words within a topic which have been extracted using a LDA technique are listed in order of appearance frequencies, FIG. 6 is a diagram for describing a method for generating a matrix using the similarities calculated in FIG. 4, FIG. 7 is a diagram for describing a method for generating a TC (topic clique) using a generated matrix, FIG. 8 is a diagram for describing a method for generating a TC according to appearance frequency, and FIG. 9 is a diagram illustrating a process of generating a TC as an algorithm.

An apparatus 1 for extracting topics according to an embodiment of the present invention may primarily extract a topic from a document set using a LDA (latent Dirichlet allocation) model technique and remove or correct duplicated or mixed words by comparing similarities between words included in the extracted topic, so that the topic for each document may be more accurately extracted. Meanwhile, the topic according to an embodiment of the present invention may refer to a set of topic words.

Referring to FIG. 1, the apparatus 1 for extracting topics according to an embodiment of the present invention may include a collection unit 100, a pre-processing unit 200, a stop word database (DB) 300, and a topic extraction unit 400.

The collection unit 100 may collect at least one document from online contents or arbitrary document data using a crawler. The collection unit 100 may remove duplicated data from the collected document through inspection.

The pre-processing unit 200 may extract a plurality of nouns from the document collected by the collection unit 100. To this end, the pre-processing unit 200 may include a morphological analysis unit 210, a noun extraction unit 220, and a stop word removal unit 230.

The morphological analysis unit 210 may analyze morphemes of sentences included in the document using a morphological analyzer. For example, as illustrated in FIG. 2, a sentence of “ [symbol] “ [symbol] ” [symbol] [symbol] ” (“Peanut U-turn” Cho Hyun-ah, former vice president with a stiff look) may be morphologically analyzed as “ [symbol] /VA+ [symbol] /ETM+ [symbol] /NNG+ [symbol] /JKG+“/SS+ [symbol] /NNG+“/SS+ [symbol] /NNP+ [symbol] /NNG+ [symbol] /NNG”.

The noun extraction unit 220 may remove the other remaining parts of the sentence while leaving only tokens corresponding to nouns from the sentence analyzed by the morphological analysis unit 210. The noun extraction unit 220 may recognize the remaining parts as nouns and extract them.

The stop word removal unit 230 may remove unnecessary words to extract topics from the nouns extracted by the noun extraction unit 22. The stop word removal unit 230 may remove the unnecessary words to extract topics from the extracted nouns using pre-built stop word data. For example, when the extracted nouns are “look, peanut U-turn, Cho Hyun-ah, vice president, Seoul, Han Jong-chan, reporter, Aviation Security Act, aircraft route change, Seo-bu District Public Prosecutors' Office, end, copyright owner, unauthorization, reproduction, redistribution, and prohibition”, and “copyright owner, unauthorization, reproduction, redistribution, and prohibition” are included in the stop word data, “copyright owner, unauthorization, reproduction, redistribution, and prohibition” may be removed from the extracted nouns.

Meanwhile, the stop word data may be generated and stored in the stop word DB 300 in advance and updated by a user or through the analysis of the extracted nouns.

The topic extraction unit 400 may extract a topic from the extracted nouns through a pre-processing process by the pre-processing unit 200. To this end, the topic extraction unit 400 may include an LDA topic extraction unit 410, a word similarity calculation unit 420, a topic separation unit 430, and a topic merging unit 440.

The LDA topic extraction unit 410 may extract a primary topic (hereinafter, referred to as “LDA topic”) from the extracted nouns using an LDA model technique.

Specifically, the LDA topic extraction unit 410 may set an appropriate parameter for extracting a topic and extract the corresponding topic. At this point, the LDA topic extraction unit 410 according to an embodiment of the present invention may set a local optimum parameter combination of an LDA model as TopicNum=35, α=1.0, β=0.1, thereby extracting the corresponding topic. FIG. 3 illustrates 7 topics among 35 topics extracted using the LDA model technique. Referring to FIG. 3, it can be seen that two correct words are mixed and extracted in Topic 07, and erroneous words are extracted in all topics except for Topics 03 and 04. In this manner, the LDA model technique may be a technique using an appearance probability distribution of words within a topic and thereby have the above-described mixed topic problem because similarities between words within a topic is not considered, and there is a probability that a topic desired by a user is not extracted. The apparatus 1 for extracting topics according to an embodiment of the present invention may solve such a mixed topic problem using similarity between words within a topic of a designated document.

To this end, the word similarity calculation unit 420 may calculate similarites between words within each topic. At this point, the word similarity calculation unit 420 according to an embodiment of the present invention may use a PMI (pointwise mutual information) technique in order to calculate the similarities between words. The PMI technique may be calculated by the following Equation 1 based on a precondition that words generated in the same context tend to have a similar meaning.

$$PMI ( {word}_{1} , {word}_{2} ) = {log}_{2} \frac{P ( {word}_{1} ⋂ {word}_{2} )}{P ( {word}_{1} ) P ( {word}_{2} )} \qquad [ Equation 1 ]$$

Here, PMI(word₁, word₂) denotes a correlation numeral value between word₁ and word₂, P(word₁∩word₂) denotes a probability that word₁ and word₂ simultaneously appear in a single sentence, and P(word₁)P(word₂) denotes a probability that the word₁ and word₂ separately appear.

The similarities between words using the PMI technique is calculated based on the following Equation 2.

[Equation 2]

PMI(A,B)=0: P(A∩B)=P(A)XP(B) 1.

That is, A and B are independent from each other.

PMI(A,B)<0:P(A∩B)<P(A)X P(B) 2.

That is, A and B have a negative relationship.

PMI(A,B)=−∞:P(A∩B)=0 3.

That is, A and B have exclusivity with respect to each other.

The word similarity calculation unit 420 may generate a PMI value between words within a topic and then generate a matrix indicating the calculated PMI value. For example, as illustrated in FIG. 4, a PMI value between respective words included in Topic 01 shown in FIG. 2 may be represented as a matrix. Meanwhile, in FIG. 4, trunk lines represented with slashes in a direction from left upper end to right lower end means that a relationship between words within a topic satisfies P(A∩B)=0, and trunk lines represented with slashes in a direction from right upper end to left lower end means that PMI(A,B)<0 is satisfied, that is, a relationship between words within a topic is a negative relationship.

The topic separation unit 430 may separate the corresponding topic in accordance with the PMI value calculated by the word similarity calculation unit 420.

Specifically, the topic separation unit 430 may separate a single topic into at least one TC (topic clique) using an appearance frequency of a topic candidate word within a topic and a PMI value between words. At this point, the appearance frequency of a topic candidate word within a topic may be calculated when the LDA topic extraction unit 410 extracts the LDA topic. Meanwhile, the TC according to an embodiment of the present invention may refer to a complete subgraph that uses a topic candidate word within a topic as a vertex and uses a PMI value between topic candidate words larger than 0 as weight of trunk lines.

Referring to FIG. 5, an appearance frequency of a topic candidate word within a topic extracted through the LDA technique may be determined, and the topic separation unit 430 may generate a TC for the corresponding topic by changing a reference word in accordance with the appearance frequency of a topic candidate word within a topic. At this point, the topic separation unit 430 may set a topic candidate word having the highest appearance frequency as the reference word in accordance with the appearance frequency of a topic candidate word within a topic. The topic separation unit 430 may determine a PMI value between the remaining topic candidate words within the topic and the set reference word in order of appearance frequencies. When there is a topic candidate word whose PMI value with the set reference word is 0 or less among the remaining topic candidate words within the topic, the topic separation unit 430 may determine that the corresponding topic candidate word has no correlation with the set reference word and thereby delete the corresponding topic candidate word from the generated matrix. The topic separation unit 430 may delete, from the matrix, a word whose PMI value with the set reference word is 0 or less among the remaining words within the topic and then add the set reference word as a vertex of the TC while deleting the set reference word from the matrix. The topic separation unit 430 may add a reference word set at first as a vertex of the TC and then set a word having the second highest appearance frequency as a reference word in accordance with the appearance frequency. The topic separation unit 430 may determine a PMI value between a reference word set at second and words remaining in the matrix in the same manner as that in the reference word set at first. The topic separation unit 430 may determine the PMI value between the reference word set at second and the words remaining in the matrix and delete, from the matrix, words whose PMI value with the reference word set at second is 0 or less among the words remaining in the matrix. The topic separation unit 430 may delete, from the matrix, the words whose PMI value with the reference word set at second is 0 or less and then add the reference word set at second as the next vertex of the TC while deleting the reference word set at second from the matrix. The topic separation unit 430 may generate the TC by repeatedly performing the above-described process until a single word remains in the matrix. For example, referring to FIGS. 5 and 6, the topic separation unit 430 may set “police” determined to have the highest appearance frequency as a first reference word. The topic separation unit 430 may determine a PMI value between “police” that is the first reference word and each of the remaining words within a matrix such as “female”, “husband”, “hospital”, “son”, “vehicle”, “crime”, “accident”, “victim”, “grandmother”, “investigation”, “security”, “reporting”, “murder”, “sequence”, “Australia”, “apartment”, “kid”, “bag”, and “Shin Eun-mi”. The topic separation unit 430 may determine that a PMI value between “police” and “kid” is −0.44 which is less than 0 when determining the PMI value in FIG. 4. The topic separation unit 430 may delete “kid” from the matrix and add “police” as a vertex of the TC, as illustrated in step 0 of FIG. 6. The topic separation unit 430 may set “female” having the second highest appearance frequency next to “police” as a second reference word in accordance with the appearance frequency. The topic separation unit 430 may determine a PMI value between “female” and each of the words remaining in the matrix such as “husband”, “hospital”, “son”, “vehicle”, “crime”, “accident”, “victim”, “grandmother”, “investigation”, “security”, “reporting”, “murder”, “sequence”, “Australia”, “apartment”, “bag, and “Shin Eun-mi”. The topic separation unit 430 may determine that the PMI value between “female” and each of “grandmother” and “Incheon” is respectively −0.09 and −0.52 which are less than 0, when determining the PMI value. Accordingly, as illustrated in step 1 of FIG. 6, the topic separation unit 430 may delete “grandmother” and “Incheon” from the matrix, and then add “female” as the next vertex of the TC while deleting “female” that is the second reference word from the matrix. By setting “husband” having the third highest appearance frequency next to “female” as a third reference word and repeatedly performing the above-described process, the topic separation unit 430 may delete “bag” from the matrix, and then add “husband” as the next vertex of the TC while deleting “husband” from the matrix, as illustrated in step 2 of FIG. 6. By repeatedly performing the above-described process until a single word remains in the matrix, the topic separation unit 430 may generate a TC having “police”, “female”, “husband”, “hospital”, “son”, “crime”, “victim”, “reporting”, and “sequence”, as illustrated in FIG. 7. Meanwhile, FIG. 7 illustrates a TC generated when “police” is set as the first reference word, and as illustrated in FIG. 7, the generated TC may include only pairs of words whose PMI values are larger than 0.

The topic separation unit 430 may generate a plurality of TCs through the above-described process by changing the first reference word in accordance with the appearance frequencies of topic candidate words. For example, as illustrated in FIG. 8, when the topic candidate words are “police”, “female”, “husband”, “hospital”, “son”, “vehicle”, “crime”, “accident”, “victim”, “grandmother”, “investigation”, “security”, “reporting”, “murder”, “sequence”, “Australia”, “apartment”, “kid”, “bag”, and “Shin Eun-mi”, the topic separation unit 430 may set “police” which is the topic candidate word having the highest appearance frequency as a first reference word in accordance with the appearance frequencies of the topic candidate words, thereby generating a TC through the above-described process. In addition, the topic separation unit 430 may set “female” which is the topic candidate word having the highest appearance frequency next to “police” as a first reference word in accordance with the appearance frequencies of the topic candidate words, thereby generating a different TC through the above-described process. In addition, the topic separation unit 430 may set “husband” which is the topic candidate word having the highest appearance frequency next to “female” as a first reference word in accordance with the appearance frequencies of the topic candidate words, thereby generating a still different TC through the above-described process. The topic separation unit 430 may generate a plurality of TCs while changing the first reference word in accordance with the appearance frequencies of the topic candidate words, and then remove duplicated TCs from the generated plurality of TCs, thereby obtaining a final TC. Meanwhile, when the above-described process of separating a topic, that is, a process of generating a TC is represented as an algorithm, FIG. 9 is obtained.

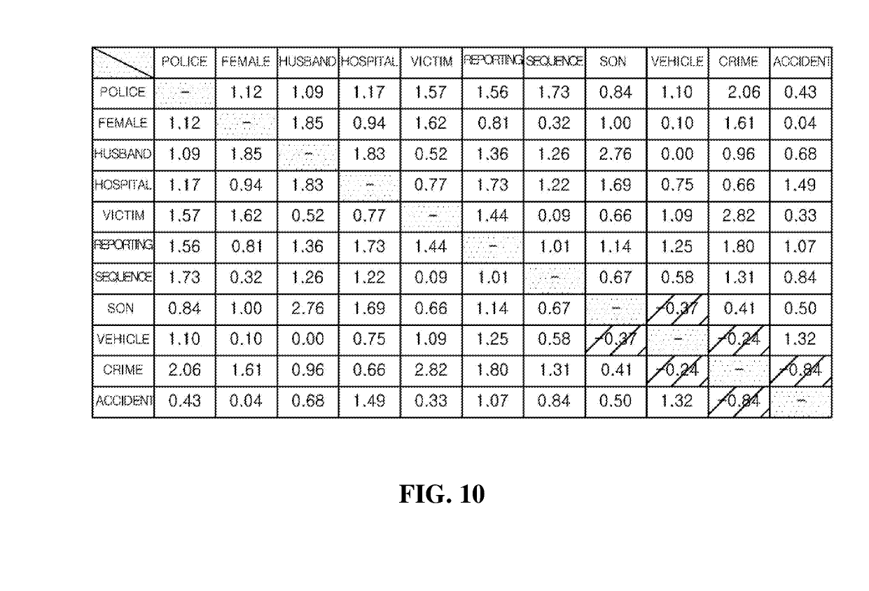

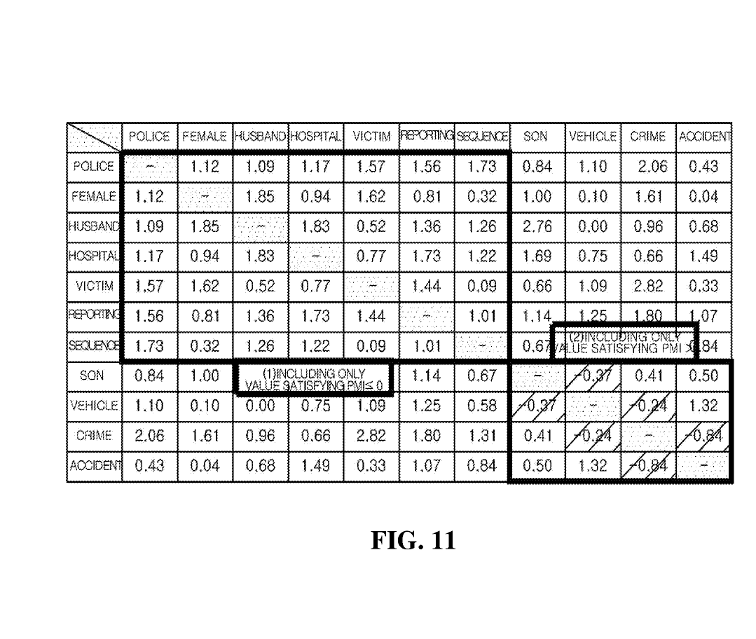

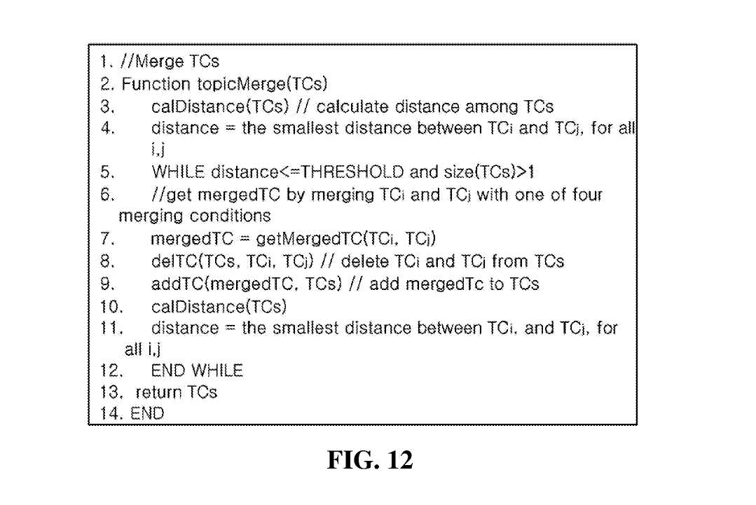

FIG. 10 is a diagram for describing a method for calculating a distance between TCs, FIG. 11 is a diagram for describing a method for merging TCs, and FIG. 12 is a diagram illustrating a TC merging algorithm.

The topic merging unit 440 may merge a plurality of TCs generated by the topic separation unit 430 in accordance with a distance between the TCs. At this point, merging between the TCs is for preventing extraction of duplicated TCs due to merging between similar TCs.

Specifically, the topic merging unit 440 may calculate a distance between TCs in order to detect TCs to be merged. At this point, the distance between TCs may be calculated as a proportion of trunk lines in which a PMI value is 0 or less from a new matrix consisting of union of vertex words between TCs. For example, when it is assumed that V(TCᵢ) is a set of vertices in TCᵢ, extracted V(TC₁) of TC₁ in FIG. 8 is {police, female, husband, vehicle, accident, victim, reporting, sequence}, V(TC₂) is {police, female, husband, hospital, son, crime, victim, reporting, sequence}, and V(TC₁)∪V(TC₂) is {police, female, husband, hospital, victim, reporting, sequence, son, vehicle, crime, accident}. At this point, the new matrix consisting of TC₁ and TC₂ is illustrated in FIG. 10. Referring to FIG. 10, the number of trunk lines in which a PMI value is 0 or less is 6, and the total number of the trunk lines is 110, and therefore the topic merging unit 440 may calculate a distance between TC₁ and TC₂ as the rate of trunk lines in which a PMI value is 0 or less from the new matrix consisting of a union of vertex words between TCs, that is,

$$Distance ( {TC}_{1} , {TC}_{2} ) = \frac{6}{110} .$$

When a distance between two TCs is a predetermined threshold value or less, the topic merging unit 440 may merge the two TCs into a single topic. At this point, as the predetermined threshold value, a value learned from experiment may be used.

Meanwhile, the topic merging unit 440 may merge TCs in accordance with four different methods. The four different methods for merging TCs are shown as follows.

Method 1: merge topics into a word set consisting of V′=V(TC₁)∪V(TC₂)

Method 2: merge topics into a word set consisting of V′+εV′, that is, ∀u,vεV′₊,PMI(u,v)>0

Method 3: align words of a word set consisting of V′₋⊂ V′, that is, ∀vεV′₋,PMI(u,v)≦0 in descending order and then add the aligned words to V′₊ one by one. However, when trunk lines in which PMI≦0 is satisfied are generated at the time of adding vertex words, the corresponding vertex may be deleted.

Method 4: TCᵢ that is, ᵢ^{max}avgPMI(TCᵢ)

According to Method 1, the topic merging unit 440 may merge two TCs having a distance that is a predetermined threshold value or less into a single topic. For example, when V(TC₁) is {police, female, husband, hospital, vehicle, accident, victim, reporting, sequence} and V(TC₂) is {police, female, husband, hospital, son, crime, victim, reporting, sequence}, the merged result may be {police, female, husband, hospital, victim, reporting, sequence, son, vehicle, crime, accident}.

According to Method 2, the topic merging unit 440 may merge topics in a manner such that resulting vertex words consist of words with PMI values between words exceeding 0. For example, topics may be merged by configuring a word set using vertex words corresponding to a portion including a value satisfying PMI>0 illustrated in FIG. 11.

According to Method 3, vertex words whose PMI value is 0 or less may be aligned in descending order and then added one by one to a set of vertex words whose PMI value exceeds 0. At this point, when trunk lines in which a PMI value is 0 or less are generated at the time of adding the vertex words, the corresponding vertex word may be deleted from a set of the vertex words whose PMI value is 0 or less. For example, in FIG. 11, the set of the vertex words whose PMI value is 0 or less is {son, vehicle, crime, accident}. When the vertex words whose PMI value is 0 or less are aligned in descending order, “son, vehicle, crime, accident” is obtained. Here, the topic merging unit 440 may first add “son” to a set of the vertex words whose PMI value exceeds 0 in accordance with the order of vertex words aligned in descending order. At this point, when “son” is added to the set of the vertex words whose PMI value exceeds 0 and then “vehicle” that is the next word in accordance with the order of vertex words aligned in descending order is added to the set of the vertex words whose PMI value exceeds 0, trunk lines in which PMI≦0 is satisfied between “vehicle” and “son” which are the added vertex words may be generated. Accordingly, the topic merging unit 440 may delete “vehicle” from the set of the vertex words whose PMI value is 0 or less. After the vertex word of “vehicle” is deleted, the trunk lines in which PMI≦0 is satisfied between “crime” that is the next vertex word in accordance with the aligned order of the vertex words and the vertex word included in the set of the vertex words whose PMI value exceeds 0 are not generated, and therefore the topic merging unit 440 may add “crime” to the set of the vertex words whose PMI value exceeds 0. When adding “crime” to the set of the vertex words whose PMI value exceeds 0 and then adding “accident” that is the following vertex word in accordance with the aligned order of the vertex words to the set of the vertex words whose PMI value exceeds 0, the topic merging unit 440 may determine that trunk lines in which PMI≦0 is satisfied between “accident” and “crime” added to the set of the vertex words whose PMI value exceeds 0 are generated. Accordingly, the topic merging unit 440 may delete the vertex word of “accident”, and extract {police, female, husband, hospital, victim, reporting, sequence, son, crime} as the merging result between TC₁ and TC₂.

According to Method 4, the topic merging unit 440 may calculate an average PMI value of each of a plurality of TCs generated by the topic separation unit 430 and extract a TC having the largest average PMI value among the calculated average PMI values as the topic merging result. For example, when the average PMI value of each of TC₁ and TC₂ shown in FIG. 8 is calculated, ᵢ^{max}avgPMI(TCᵢ) may be 1.26, a TC corresponding to 1.26 may be the TC₂, and therefore the topic merging result may be {police, female, husband, hospital, son, crime, victim, reporting, sequence}.

Meanwhile, when the above-described topic merging process is represented as an algorithm, results shown in FIG. 12 may be obtained.

The topic merging unit 440 may extract a final topic based on the merging result extracted according to any one of the above-described four topic merging methods.

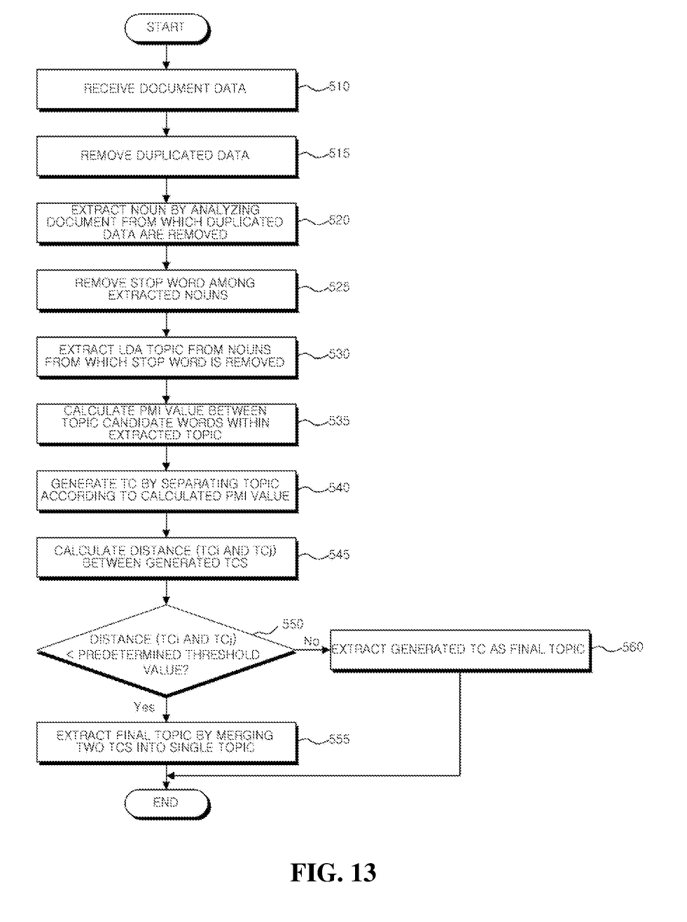

Hereinafter, a method for extracting topics according to an embodiment of the present invention will be described with reference to FIG. 13.

In FIG. 13, a method for extracting a final topic by integrating topics according to Method 1 among the above-described four topic merging methods will be described.

First, the method receives document data collected by the collection unit 100 in operation 510 and removes duplicated data by inspecting the received document data in operation 515.

The method extracts nouns by morphologically analyzing the document from which the duplicated data are removed in operation 520 and removes stop words from the extracted nouns based on a comparison between the extracted nouns and predetermined stop word data in operation 525.

The method extracts an LDA topic from the nouns from which the stop words are removed by applying an LDA technique to the nouns from which the stop words are removed in operation 530.

The method calculates a PMI value between topic candidate words within the extracted topic in order to solve a problem of mixed topics in the extracted topics in operation 535.

At this point, PMI indicates a ratio of a probability that two words simultaneously appear in a single sentence to a probability that two words separately appear, and correlation between the two words is higher along with an increase in the PMI value.

The method generates at least one TC by separating the topic in accordance with the calculated PMI value in operation 540.

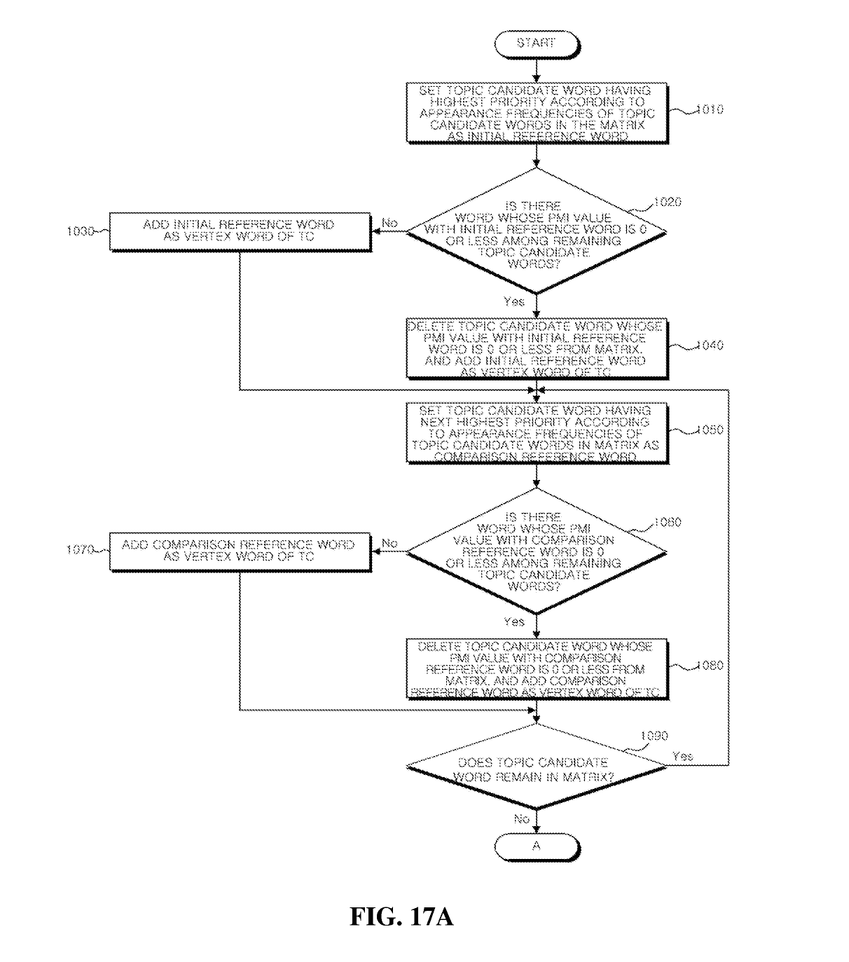

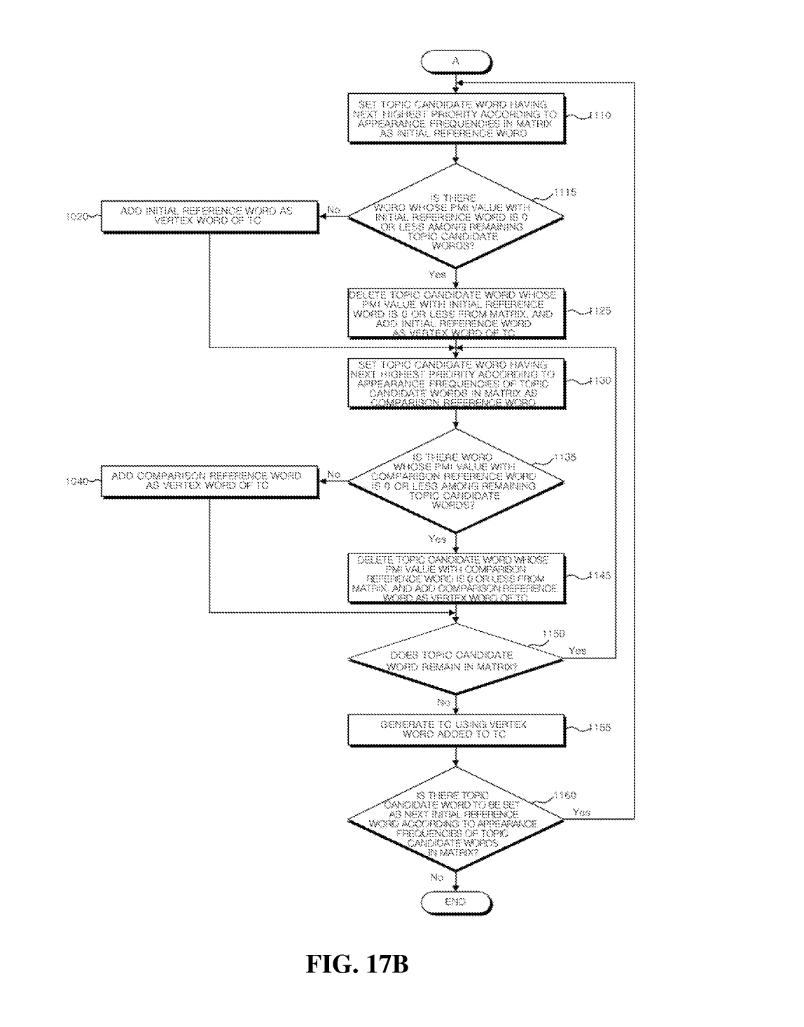

At this point, a method for separating the topic in accordance with the PMI value will be described in detail with reference to FIGS. 17A and 17B.

The method calculates a distance between the generated TCs Distance(TCᵢ,TCⱼ) in operation 545 and determines whether the calculated distance between the TCs Distance(TCᵢ,TCⱼ) is less than a predetermined threshold value in operation 550.

At this point, the distance between the TCs Distance(TCᵢ,TCⱼ) may be obtained by calculating a proportion of trunk lines in which a PMI value is 0 or less from a new matrix consisting of union of vertex words between two TCs. In addition, the determining whether the distance between the TCs Distance(TCᵢ,TCⱼ) is less than the predetermined threshold value is for detecting whether the two TCs are similar to each other.

When it is determined that the distance between the TCs Distance(TCᵢ,TCⱼ) is less than the predetermined threshold value in operation 550, the method recognizes that the corresponding two TCs are similar to each other and extracts a final topic by merging the two TCs into a single topic in operation 555.

In addition, when it is determined that the distance between the TCs Distance(TCᵢ,TCⱼ) is the predetermined threshold value or larger in operation 550, the method recognizes that each of the TCs has a unique topic and extracts the generated TC as the final topic in operation 560.

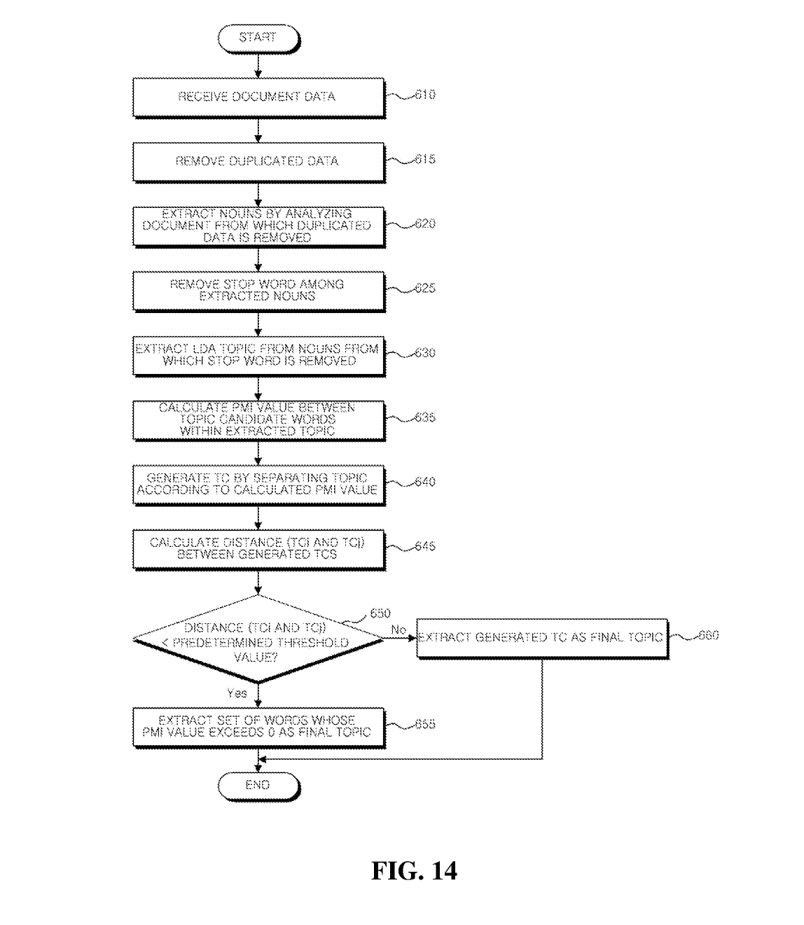

Hereinafter, a method for extracting topics according to another embodiment of the present invention will be described with reference to FIG. 14. In FIG. 14, a method for extracting a final topic by integrating topics according to Method 2 among the above-described four topic merging methods will be described.

First, the method receives document data collected by the collection unit 100 in operation 610 and removes duplicated data by inspecting the received document data in operation 615.

The method extracts nouns by morphologically analyzing the document from which the duplicated data is removed in operation 620 and removes stop words from the extracted nouns based on a comparison between the extracted nouns and predetermined stop word data in operation 625.

The method extracts an LDA topic from the nouns from which the stop words are removed by applying an LDA technique to the nouns from which the stop words are removed in operation 630.

The method calculates a PMI value between topic candidate words within the extracted topic in order to solve a problem of mixed topics in the extracted topics in operation 635.

The method generates at least one TC by separating the topic in accordance with the calculated PMI value in operation 640.

At this point, a method for separating the topic in accordance with the PMI value will be described in detail with reference to FIGS. 17A and 17B.

The method calculates a distance between the generated TCs Distance(TCᵢ,TCⱼ) in operation 645 and determines whether the calculated distance between the TCs Distance(TCᵢ,TCⱼ) is less than a predetermined threshold value in operation 650.

When it is determined that the distance between the TCs Distance(TCᵢ,TCⱼ) is less than the predetermined threshold value in operation 650, the method recognizes that the corresponding two TCs are similar to each other and extracts a set of words whose PMI value exceeds 0 as a final topic from a new matrix consisting of the two TCs in operation 655.

In addition, when it is determined that the distance between the TCs Distance(TCᵢ,TCⱼ) is the predetermined threshold value or larger in operation 650, the method recognizes that each of the TCs has a unique topic and extracts the generated TC as the final topic in operation 660.

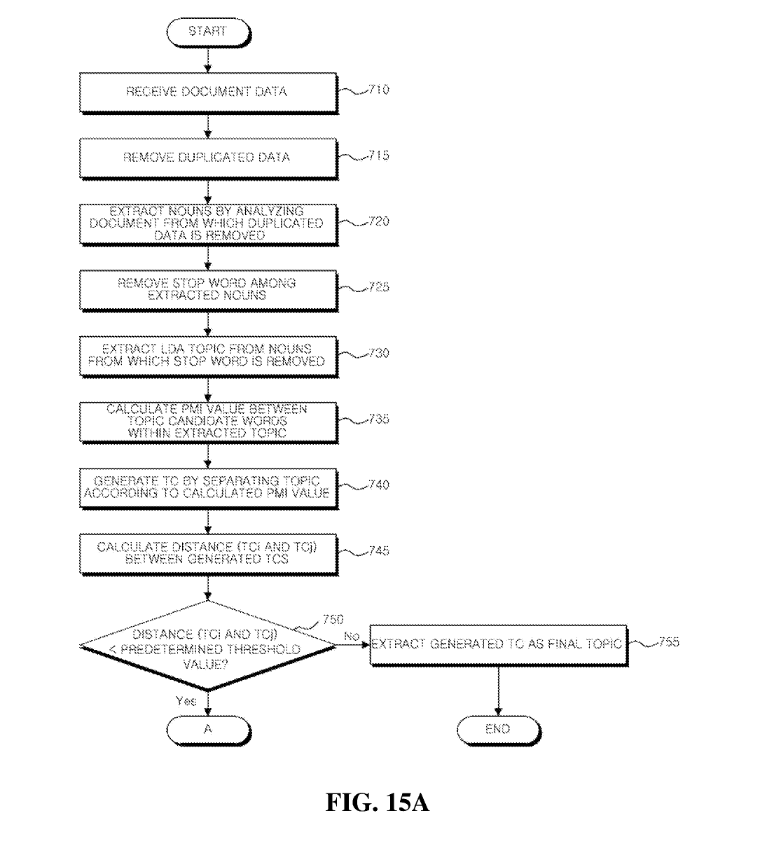

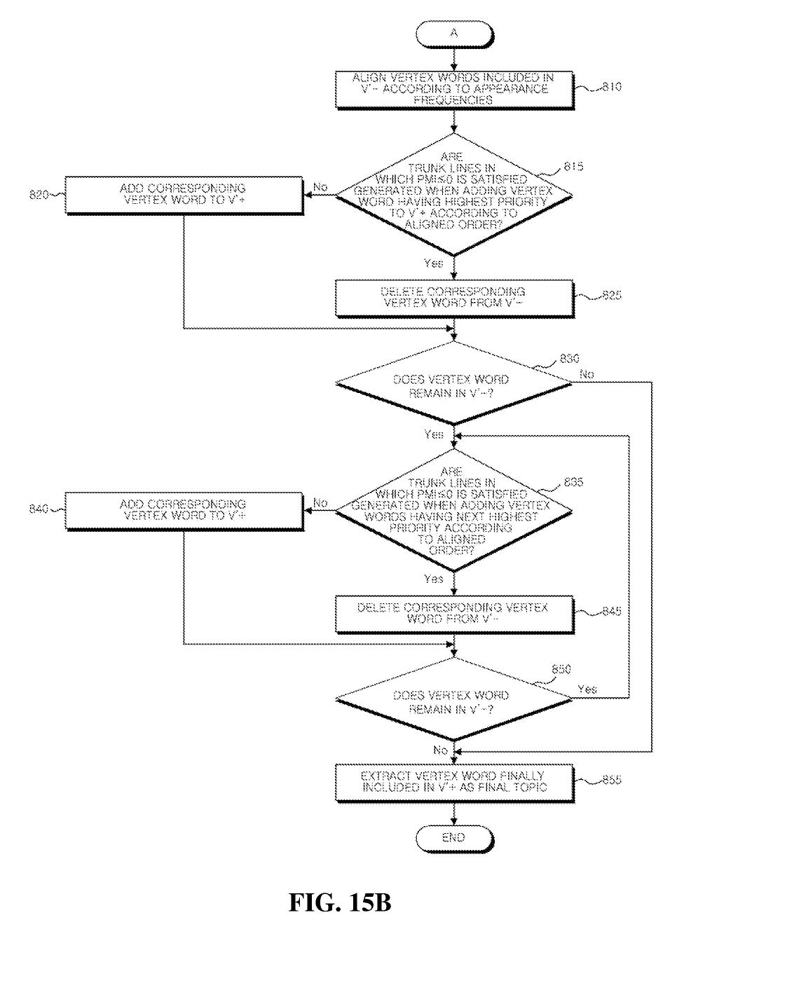

Hereinafter, a method for extracting topics according to still another embodiment of the present invention will be described with reference to FIGS. 15A and 15B. In FIGS. 15A and 15B, a method for extracting a final topic by integrating topics according to Method 3 among the above-described four topic merging methods will be described.

First, referring to FIG. 15A, the method receives document data collected by the collection unit 100 in operation 710 and removes duplicated data by inspecting the received document data in operation 715.

The method extracts nouns by morphologically analyzing the document from which the duplicated data are removed in operation 720 and removes stop words from the extracted nouns based on a comparison between the extracted nouns and predetermined stop word data in operation 725.

The method extracts an LDA topic from the nouns from which the stop words are removed by applying an LDA technique to the nouns from which the stop words are removed in operation 730.

The method calculates a PMI value between topic candidate words within the extracted topic in order to solve a problem of mixed topics in the extracted topics in operation 735.

The method generates at least one TC by separating the topic in accordance with the calculated PMI value in operation 740.

At this point, a method for separating the topic in accordance with the PMI value will be described in detail with reference to FIGS. 17A and 17B.

The method calculates a distance between the generated TCs Distance(TCᵢ,TCⱼ) in operation 745 and determines whether the calculated distance between the TCs Distance(TCᵢ,TCⱼ) is less than a predetermined threshold value in operation 750.

When it is determined that the distance between the TCs Distance(TCᵢ,TCⱼ) is the predetermined threshold value or larger in operation 750, the method recognizes that each of the TCs has a unique topic and extracts the generated TC as the final topic in operation 755.

Referring to FIG. 15B, when it is determined that the distance between the TCs Distance(TCᵢ,TCⱼ) is less than the predetermined threshold value through FIG. 15A in operation 750, the method aligns vertex words included in a set V′₋ of vertex words whose PMI value is 0 or less in a new matrix consisting of the two TCs in accordance with appearance frequencies, that is, in descending order of the appearance frequencies in operation 810.

The method determines whether trunk lines in which PMI≦0 is satisfied are generated when adding the vertex word determined to have the highest priority in accordance with the aligned order of the vertex words among the vertex words whose PMI value is 0 or less to a set V′₊ of the vertex words whose PMI value exceeds 0 in operation 815.

At this point, the determining whether the trunk lines in which PMI≦0 is satisfied are generated when adding the vertex word may be for determining whether at least one vertex word included in the set V′₊ of the vertex words whose PMI value exceeds 0 has a relationship satisfying PMI≦0 with the vertex word determined to have the highest priority in accordance with the aligned order when adding the vertex word determined to have the highest priority in accordance with the aligned order to the set V′₊ of the vertex words whose PMI value exceeds 0.

At this point, when it is determined that the trunk lines in which PMI≦0 is satisfied are not generated at the time of adding the vertex word determined to have the highest priority in accordance with the aligned order to the set V′₊ of the vertex words whose PMI value exceeds 0 in operation 815, the method recognizes that the corresponding vertex word has a correlation with the set V′₊ of the vertex words whose PMI value exceeds 0 and adds the corresponding vertex word to the set V′₊ of the vertex words whose PMI value exceeds 0 in operation 820.

In addition, when it is determined that the trunk lines in which PMI≦0 is satisfied are generated at the time of adding the vertex word determined to have the highest priority in accordance with the aligned order to the set V′₊ of the vertex words whose PMI value exceeds 0 in operation 820, the method recognizes that the corresponding vertex word does not have a correlation with the set V′₊ of the vertex words whose PMI value exceeds 0 and deletes the corresponding vertex word in operation 825.

The method adds or deletes the vertex word determined to have the highest priority in accordance with the aligned order and then determines whether there is a vertex word remaining in the set V′₋ of the vertex words whose PMI value is 0 or less in operation 830.

At this point, when it is determined that there is a vertex word remaining in the set V′₋ of the vertex words whose PMI value is 0 or less in operation 830, the method determines whether trunk lines in which PMI≦0 is satisfied are generated at the time of adding the vertex word having the next highest priority in accordance with the aligned order to the set V′₊ of the vertex words whose PMI value exceeds 0 in operation 835.

When it is determined that trunk lines in which PMI≦0 is satisfied are not generated at the time of adding the vertex word having the next highest priority in accordance with the aligned order to the set V′₊ of the vertex words whose PMI value exceeds 0 in operation 835, the method recognizes that the corresponding vertex word has correlation with the set V′₊ of the vertex words whose PMI value exceeds 0 and adds the corresponding vertex word to the set V′₊ of the vertex words whose PMI value exceeds 0 in operation 840.

In addition, when it is determined that trunk lines in which PMI≦0 is satisfied are generated at the time of adding the vertex word having the next highest priority in accordance with the aligned order to the set V′₊ of the vertex words whose PMI value exceeds 0 in operation 835, the method recognizes that the corresponding vertex word does not have correlation with the set V′₊ of the vertex words whose PMI value exceeds 0, and deletes the corresponding vertex word in operation 845.

The method deletes the vertex word having the next highest priority from the set V′₋ of the vertex words whose PMI value is 0 or less in operation 845 and then determines whether there is a vertex word remaining in the set V′₋ of the vertex words whose PMI value is 0 or less in operation 850.

At this point, when it is determined that there is a vertex word remaining in the set V′₋ of the vertex words whose PMI value is 0 or less in operation 850, the method returns to operation 835 and repeatedly performs the above-described process until there is no vertex word remaining in the set V′₋ of the vertex words whose PMI value is 0 or less.

When it is determined that there is no vertex word remaining in the set V′₋ of the vertex words whose PMI value is 0 or less in operations 830 and 850, the method finally extracts the vertex word included in the set V′₊ of the vertex words whose PMI value exceeds 0 as a final topic in operation 855.

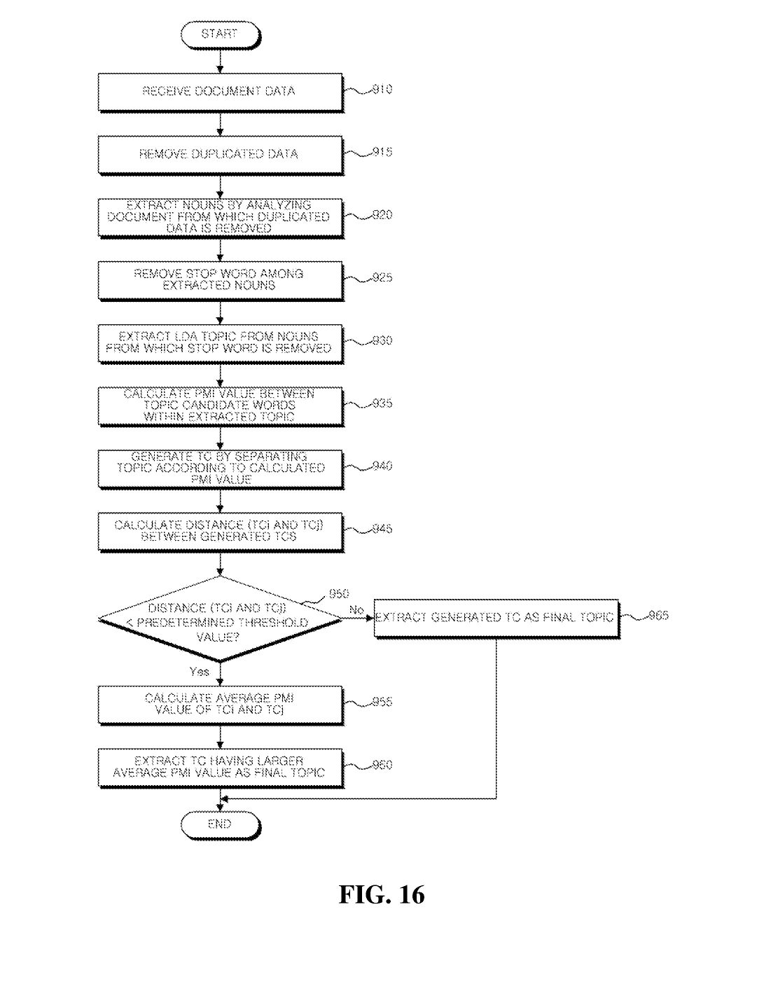

Hereinafter, a method for extracting topics according to yet another embodiment of the present invention with reference to FIG. 16. In FIG. 16, a method for extracting a final topic by integrating topics according to Method 4 among the above-described four topic merging methods will be described.

First, the method receives document data collected by the collection unit 100 in operation 910 and removes duplicated data by inspecting the received document data in operation 915.

The method extracts nouns by morphologically analyzing the document from which the duplicated data is removed in operation 920 and removes stop words from the extracted nouns based on a comparison between the extracted nouns and predetermined stop word data in operation 925.

The method extracts an LDA topic from the nouns from which the stop words are removed by applying an LDA technique to the nouns from which the stop words are removed in operation 930.

The method calculates a PMI value between topic candidate words within the extracted topic in order to solve a problem of mixed topics in the extracted topics in operation 935.

The method generates at least one TC by separating the topic in accordance with the calculated PMI value in operation 940.

At this point, a method for separating the topic in accordance with the PMI value will be described in detail with reference to FIGS. 17A and 17B.

The method calculates a distance between the generated TCs Distance(TCᵢ,TCⱼ) in operation 945 and determines whether the calculated distance between the TCs Distance(TCᵢ,TCⱼ) is less than a predetermined threshold value in operation 950.

When it is determined that the distance between the TCs Distance(TCᵢ,TCⱼ) is less than the predetermined threshold value in operation 950, the method extracts a set of words whose PMI value exceeds 0 as a final topic from a new matrix consisting of the two TCs in operation 955.

In addition, when it is determined that the distance between the TCs Distance(TCᵢ,TCⱼ) is the predetermined threshold value or larger in operation 950, the method calculates an average PMI value of each of TCᵢ and TCⱼ in operation 955 and extracts the TC having the larger calculated average PMI value between TCᵢ and TCⱼ as the final topic in operation 960.

In addition, when it is determined that the distance between the TCs Distance(TCᵢ,TCⱼ) is the predetermined threshold value or larger in operation 950, the method recognizes that each TC has a unique topic and extracts the generated TC as the final topic in operation 965.

Hereinafter, a method for generating a TC according to an embodiment of the present invention will be described with reference to FIGS. 17A and 17B.

Referring to FIG. 17A, the method sets, as an initial reference word, a topic candidate word having the highest priority in accordance with appearance frequencies of topic candidate words in a matrix consisting of the topic candidate words and calculated PMI values in operation 1010.

At this point, the initial reference word may be a word that is used to select only the topic candidate words having a correlation with the corresponding initial reference word and cluster the selected topic candidate words into a TC as a reference of a TC generated in order to separate the corresponding topic. The apparatus 1 for extracting topics according to an embodiment of the present invention may generate a TC while changing such an initial reference word, thereby generating at least one TC from a single topic.

The method determines whether there is a word whose PMI value with the set initial reference word is 0 or less among the remaining topic candidate words except for the set initial reference word within the matrix in operation 1020 and adds the initial reference word as a vertex word of the corresponding TC when there is no word whose PMI value with the set initial reference word is 0 or less among the remaining topic candidate words in operation 1030.

At this point, the adding the initial reference word as the vertex word of the TC is for adding the corresponding initial reference word as a word within the TC generated, in order to separate the topic while deleting the corresponding initial reference word from the matrix at the same time.

In addition, when there is a word whose PMI value with the set initial reference word is 0 or less among the remaining topic candidate words, the method recognizes that the corresponding topic candidate word does not have a correlation with the initial reference word, deletes the topic candidate word whose PMI value with the set initial reference word is 0 or less from the matrix, and adds the initial reference word as the vertex word of the TC in operation 1040.

The method adds the initial reference word as the vertex word of the TC in operation 1030 and 1040, then determines the topic candidate word having the next highest priority in accordance with appearance frequencies of the topic candidate words in the matrix, and sets the determined topic candidate word as a comparison reference word in operation 1050.

After setting the comparison reference word in operation 1050, the method determines whether there is a word whose PMI value with the comparison reference word is 0 or less among the remaining topic candidate words remaining in the matrix in operation 1060 and adds the set comparison reference word as the vertex word of the TC when there is no word whose PMI value with the set comparison reference word is 0 or less among the remaining topic candidate words in operation 1070.

In addition, when there is a word whose PMI value with the set comparison reference word is 0 or less among the remaining topic candidate words, the method recognizes that the corresponding topic candidate word does not have a correlation with the comparison reference word, deletes the topic candidate word whose PMI value with the set comparison reference word is 0 or less from the matrix, and adds the comparison reference word as the vertex word of the TC in operation 1080.

The method adds the topic candidate word having high appearance frequency next to the topic candidate word having the highest priority to the TC, determines whether there is a topic candidate word remaining in the matrix in operation 1090, returns to operation 1050 when it is determined that there is a topic candidate word remaining in the matrix and repeatedly performs the above-described process until a single topic candidate word remains in the matrix.

Referring to FIG. 17B, when it is determined that there is no topic candidate word remaining in the matrix through FIG. 17A in operation 1090, the method sets the topic candidate word having the next highest priority in accordance with the appearance frequencies of the topic candidate words in the matrix as the initial reference word in operation 1110.

The method determines whether there is a word whose PMI value with the set initial reference word is 0 or less among the remaining topic candidate words remaining in the matrix in operation 1115 and adds the initial reference word as the vertex word of the TC when it is determined that there is no word whose PMI value with the set initial reference word is 0 or less among the remaining topic candidate words in operation 1120.

At this point, the adding the initial reference word as the vertex word of the TC is for adding the initial reference word as a word within the TC generated in order to separate the corresponding topic while deleting the corresponding initial reference word.

In addition, when it is determined that there is a word whose PMI value with the set initial reference word is 0 or less among the remaining topic candidate words, the method recognizes that the corresponding topic candidate word does not have a correlation with the initial reference word, deletes the topic candidate word whose PMI value with the set initial reference word is 0 or less from the matrix, and adds the initial reference word as the vertex word of the TC in operation 1125.

After adding the initial reference word as the vertex word of the TC in operations 1120 and 1125, the method determines the topic candidate word having the next highest priority in accordance with the appearance frequencies of the topic candidate words in the matrix, and sets the determined topic candidate word as a comparison reference word in operation 1130.

After setting the comparison reference word in operation 1130, the method determines whether there is a word whose PMI value with the comparison reference word is 0 or less among the remaining topic candidate words remaining in the matrix in operation 1135 and adds the set comparison reference word as the vertex word of the TC when it is determined that there is no word whose PMI value with the set comparison reference word is 0 or less among the remaining topic candidate words in operation 1140.

In addition, when it is determined that there is a word whose PMI value with the set comparison reference word is 0 or less among the remaining topic candidate words, the method recognizes that the corresponding topic candidate word does not have a correlation with the comparison reference word, deletes the topic candidate word whose PMI value with the set comparison reference word is 0 or less from the matrix, and adds the comparison reference word as the vertex word of the TC in operation 1145.

After adding the comparison reference word to the TC with respect to the comparison reference word in which the topic candidate word having the next highest priority is set as the initial reference word, the method determines whether there is a topic candidate word remaining in the matrix in operation 1150.

At this point, when it is determined that there is a topic candidate word remaining in the matrix, the method returns to operation 1130 and repeatedly performs the above-described process until a single topic candidate word remains in the matrix.

In addition, the method generates a TC using the vertex words added to the TC when it is determined that there is no topic candidate word remaining in the matrix in operation 1155.

In addition, after setting the topic candidate word having the next highest priority as the initial reference word to generate the TC in operation 1155, the method determines whether there is a topic candidate word to be set as the next initial reference word in accordance with the appearance frequencies of the topic candidate words within the matrix in operation 1160, returns to operation 1110 when it is determined that there is a topic candidate word to be set as the next initial reference word, repeatedly performs the above-described process to generate the TC for the initial reference word to be set as the next initial reference word, and terminates the corresponding process when it is determined that there is no topic candidate word to be set as the next initial reference word.

As described above, according to an embodiment of the present invention, it is possible to more accurately extract topics by correcting the problem of duplicated topic and the problem of mixed topics.

The technique for extracting topics from the document data according to the present disclosure described above can be implemented in the form of program instructions that are executable through applications or various computer components, and be recorded in a computer-readable recording medium. The computer-readable recording medium may include program instructions, a data file, a data structure, and the like, solely or in combination.

The media and program instructions may be those specifically designed and constructed for the embodiments of the invention or they may be of the kind well-known and available to those having ordinary skill in the computer software arts. The embodiments according to the present disclosure described above can be implemented in the form of program instructions that are executable through various computer components, and be recorded in a computer-readable recording medium. The computer-readable recording medium may include program instructions, a data file, a data structure, and the like, solely or in combination. The program instructions recorded in the computer-readable recording medium may be the instructions specially designed and configured for the present disclosure or the instructions known to and used by those skilled in the art of the computer software field. Examples of the computer-readable recording medium include: a magnetic medium, such as a hard disk, a floppy disk, and a magnetic tape; an optical recording medium, such as a CD-ROM and a DVD; a magneto-optical medium, such as a floptical disk; and a hardware device specially configured to store and execute program instructions, such as a ROM, a RAM, a flash memory, and the like. The program instructions include, for example, a high-level language code that can be executed by a computer using an interpreter or the like, as well as a machine code such as the code generated by a compiler. The hardware devices can be configured to operate as one or more software modules in order to perform the processing according to the present disclosure, and vice versa.

Although the present disclosure has been described in the foregoing by way of specific particulars such as specific components as well as finite embodiments and drawings, they are provided only for assisting in the understanding of the present disclosure, and the present disclosure is not limited to the embodiments. It will be apparent that those skilled in the art can make various modifications and changes thereto from these descriptions.

1-12. (canceled)

13. A method for extracting topics from documents comprising:
collecting documents and extracting nouns therefrom;
extracting latent Dirichlet allocation (LDA) topics from the extracted nouns using an LDA technique;
calculating similarities between topic candidate words within the extracted LDA topics;
separating the extracted LDA topics in accordance with the calculated similarities between the topic candidate words; and
merging the separated LDA topics to extract a final topic.

14. The method for extracting topics from documents according to claim 13, wherein the calculating similarities between topic candidate words within the extracted LDA topics comprises calculating a plurality of pointwise mutual information (PMI) values between the topic candidate words.

15. The method for extracting topics from documents according to claim 14, wherein the calculating a plurality of PMI values between the topic candidate words comprises:
selecting arbitrarily two words among the topic candidate words, and
computing a ratio of a probability that the selected two words appear simultaneously in a single sentence to a probability that the selected two words appear separately.

16. The method for extracting topics from documents according to claim 13, wherein the separating the extracted LDA topics in accordance with the calculated similarities between the topic candidate words comprises:
calculating a plurality of PMI values between the topic candidate words;
generating a first matrix indicating the calculated plurality of PMI values;
calculating appearance frequencies of the topic candidate words within the generated first matrix;
identifying a plurality of initial reference words in accordance with the calculated appearance frequencies, and
generating a topic clique (TC) for each of the plurality of the identified initial reference words to separate the extracted LDA topics.

17. The method for extracting topics from documents according to claim 16, wherein the calculating a plurality of PMI values between the topic candidate words comprises:
selecting arbitrarily two words among the topic candidate words, and
computing a ratio of a probability that the selected two words appear simultaneously in a single sentence to a probability that the selected two words appear separately.

18. The method for extracting topics from documents according to claim 16, wherein the generating a TC for each of the plurality of the identified initial reference words to separate the extracted LDA topics comprising:
a first process for setting vertex words of the TC in the matrix,
a second process for refining the topic candidate word in the matrix, and
a third process for repeatedly performing the second process until a single topic candidate word remains in the matrix in the second process.

19. The method for extracting topics from documents according to claim 18, wherein the first process for setting vertex words of the TC in the matrix comprises:
determining a PMI value between the initial reference words and the remaining topic candidate words except for the initial reference words among the topic candidate words included in the matrix,
deleting the topic candidate word whose PMI value with the initial reference word is 0 or less from the matrix, and
moving the initial reference word to the vertex words of the TC in the matrix.

20. The method for extracting topics from documents according to claim 18, wherein the second process for refining the topic candidate word in the matrix comprises:
setting a comparison reference word,
determining a PMI value between each of the topic candidate word whose PMI value with the initial reference word is 0 or less and the topic candidate word included in the matrix from which the initial reference word is deleted with the comparison reference word, and
deleting the topic candidate word whose PMI value with the comparison reference word is 0 or less.

21. The method for extracting topics from documents according to claim 20, wherein the setting a comparison reference word comprises identifying the topic candidate word having the next highest priority in accordance with the appearance frequencies of the topic candidate words among the topic candidate words included in the matrix from which the topic candidate word whose PMI value with the initial reference word is 0 or less is deleted.

22. The method for extracting topics from documents according to claim 16, wherein the merging the separated LDA topics to extract a final topic comprises:
generating a second matrix as a union of vertex words included in arbitrary two TCs among the TCs for the initial reference words,
calculating a distance between the TCs, and
merging the TCs in accordance with the calculated distance between the TCs.

23. The method for extracting topics from documents according to claim 22, wherein the calculating a distance between the TCs comprises:
identifying trunk lines in which a PMI value is 0 or less from the generated second matrix,
computing a ratio of the number of the trunk lines to the number of overall trunk lines included in the generated second matrix.

24. The method for extracting topics from documents according to claim 22, wherein the merging the TCs in accordance with the calculated distance between the TCs comprises merging the arbitrary two TCs into a single topic.

25. The method for extracting topics from documents according to claim 22, wherein the merging the TCs in accordance with the calculated distance between the TCs comprises merging the TCs by configuring a word set using vertex words corresponding to a portion in which the PMI value exceeds 0 in the generated second matrix.

26. The method for extracting topics from documents according to claim 22, wherein the merging the TCs in accordance with the calculated distance between the TCs comprises adding of the vertex words included in a negative vertex word set to a positive vertex word set in accordance with the PMI values, thereby merging the TCs.

27. The method for extracting topics from documents according to claim 26, wherein:
the negative vertex word set corresponds to a portion in which the PMI value is 0 or less in the generated second matrix,
the positive vertex word set corresponds to a portion in which the PMI value exceeds 0 in the generated second matrix, and
the PMI values are the PMI values with vertex words included in the positive vertex word set.

28. The method for extracting topics from documents according to claim 26, wherein the adding of the vertex words included in a negative vertex word set to a positive vertex word set in accordance with the PMI values comprises:
determining a PMI value between the vertex words,
determining whether the vertex word having the highest priority in accordance with the appearance frequencies in the negative vertex word set generates trunk lines in which a PMI value with at least one of the vertex words included in the positive vertex word set is 0 or less, and
adding the vertex word having the highest priority to the positive vertex word set.

29. The method for extracting topics from documents according to claim 28, wherein the determining a PMI value between the vertex words comprises determining a PMI value between the vertex words included in the positive vertex word set while selecting the vertex words in accordance with the appearance frequencies among the vertex words included in the negative vertex word set and adding the selected vertex words to the positive vertex word set.

30. The method for extracting topics from documents according to claim 28, wherein the adding the vertex word having the highest priority to the positive vertex word set is performed when the vertex word having the highest priority does not generates the trunk lines in which a PMI value with at least one of the vertex words included in the positive vertex word set is 0 or less.

31. The method for extracting topics from documents according to claim 22, wherein the merging the TCs in accordance with the calculated distance between the TCs comprises:
calculating an average PMI value of each of the arbitrary two TCs, and
extracting the TC having a larger average PMI value between the arbitrary two TCs, thereby merging the TCs.

32. An apparatus for extracting topics from documents comprising:
a noun extraction unit that collects documents to extract nouns;
an LDA topic extraction unit that extracts LDA topics from the extracted nouns using an LDA technique;
a topic separation unit that calculates similarities between topic candidate words within the LDA topics, and separating the LDA topics in accordance with the calculated similarities between the topic candidate words; and
a topic merging unit that merges the separated LDA topics in accordance with distances between the separated LDA topics to extract a final topic.
